(19) United States
(12) Patent Application Publication
(10) Pub. No.: US 2012/0208888 A1
(43) Pub. Date: Aug. 16, 2012

(54) Biocide compositions and related methods

(76) Inventor: Roy W. Martin, Downers Grove, IL (US)

(21) Appl. No.: 13/066,226

(22) Filed: Apr. 8, 2011

Related U.S. Application Data
(63) Continuation-in-part of application No. 12/932,469, filed on Feb. 25, 2011.
Application No. 12/932,469 is a continuation-in-part of application No. 12/931,896, filed on Feb. 14, 2011.

(51) Int. Cl. A01N 37/02; A01N 37/06; A01P 1/00; A01N 37/00

(52) U.S. Cl. 514/574; 514/553

(57) ABSTRACT

The invention relates to biocide compositions comprising organic acyl polyoxychlorine and methods for producing said biocide compositions. The biocide compositions form reactive oxygen species when contacted by microorganisms, proteinaceous substances, and oxidizable organic based contaminants.

### RELATED APPLICATIONS

This application is a Continuation-in-Part (CIP) of U.S. patent application Ser. No. 12/932,469 filed on 25 Feb. 2011, which is a CIP of U.S. patent application Ser. No. 12/931,896 filed on 14 Feb. 2011. The contents of these patent applications are incorporated by reference herein.

### FIELD OF INVENTION

The present invention relates to biocides and methods for killing microorganisms.

### BACKGROUND

Oxidizing biocides are commonly used for the treatment of recirculating systems such as industrial cooling systems and swimming pools, disinfecting hard surfaces, sanitizing food product surfaces, food processing equipment, and sterilizing surgical instruments.

Chlorine dioxide is an oxychlorine compound that is an effective oxidizing biocide that is currently approved for use in these types of application.

In order to obtain sporicidal registration through the U.S. EPA and FDA, meeting the requirements of AOAC method 966.04 is necessary. The AOAC method 966.04 is considered to be one of the most, if not the most difficult test to meet due to the nature of the test. C. Sporogenes and B. Subtilis spores are affixed to ceramic cylinders in a proteinaceous and soil based matrix. This matrix is difficult to penetrate and as a result, otherwise extremely effective biocides such as chlorine dioxide and peracetic acid can require as much as 1 hour or more of contact time with 1000 ppm as ClO₂ to meet the requirements for being sporicidal using AOAC method 966.04.

Furthermore, at such high concentrations of ClO₂ needed to meet the criteria for being regarded as a sporicidal, the high volatility of chlorine dioxide can be a significant issue and health concern.

There is a need for a fast acting biocide composition that can provide the benefits of chlorine dioxide without its limitations, while improving penetration of biofilms, proteinaceous deposits and accelerate inactivation of microbiological organisms including mycobacterium, spores, and oocyst at an accelerated rate.

U.S. Pat. No. 6,866,870 (“870”) discloses a biocide composition formed from ingredients comprising peroxide and a hypochlorite, wherein the biocide composition is formed by adding the peroxide ingredient to the hypochlorite ingredient so that the weight ratio of the hypochlorite to the peroxide is in the range of about 10:1 to 100:1.

The “870” patent is very limited in that: the peroxide ingredient must be added to the hypochlorite ingredient in a specific sequence; the method of producing the biocide composition requires a two-component system (bi-component); the biocide composition cannot be a solid composition; and the weight ratio of hypochlorite to peroxide must be at least 10:1, and the method of producing a biocide composition must be carried out in essentially the absence of organic matter, thereby eliminating the use of organic acids, anhydrides, surfactants and the like.

U.S. Patent Application No. 2011/0014276 A1 discloses an antimicrobial preservative for use in an ophthalmic product, the preservative comprising from about 0.005 wt. % to about 0.20 wt. % chlorite compound and from about 0.005 wt. % to about 0.05 wt. % peroxy compound, wherein the preservative does not generate chlorine dioxide, and wherein the preservative is at a pH range between about 6.0 and about 8.8.

U.S. Pat. No. 2,482,891 discloses a solid composition comprising an acid anhydride and alkali and alkali earth metal chlorite for producing chlorine dioxide.

U.S. Pat. No. 6,096,348 discloses a disinfectant and/or sterilant comprising from 1 to 30% hydrogen peroxide and a carboxylic acid and carboxylate salt.

### SUMMARY OF THE INVENTION

The present invention is based on the discovery that organic acyl polyoxychlorine compounds can be produced and/or stored in the form of an aqueous solution. These powerful oxidizing compounds were found to be unexpectedly stable in an aqueous solution as long as the pH is less than about 5.0. However when the pH is increased much above 5.0 and oxidizable organics are contacted with the aqueous solution, the organic acyl polyoxychlorine compounds undergo extremely vigorous decomposition. The ability to produce organic acyl polyoxychlorine compounds in an aqueous solution as well as produce, stabilize and store these compounds in an aqueous solution brings to light a new generation of biocide compositions and bleach compositions that provide unprecedented performance and can be produced from components that are reduced to compounds Generally Regarded As Safe (GRAS).

Acid anhydrides have been used in producing chlorine dioxide as an acidulent or in direct reaction with alkali and earth alkali chlorites. Alkali and earth alkali chlorates have been used to produce chlorine dioxide by reduction of chlorates in strong acid solutions.

It has been discovered that organic acyl polyoxychlorine compounds can be produced that are stable in aqueous solutions and provide extremely efficient and effective biocide and bleach solutions.

While several methods for producing the biocide composition of the invention will be introduced, one expedient method comprises contacting an acid anhydride with an aqueous solution of polyoxychlorine anions comprising at least one of a chlorate anion having the general formula ClO₃⁻ and a perchlorate anion having the general formula ClO₄⁻. The reaction is allowed to continue until the acid anhydride is substantially depleted. The aqueous biocide composition should have a pH of less than or equal to 7.0, more preferably a pH of less than 6.0, and most preferably a pH of less than 5.0. Once the biocide composition has been produced, the pH may be adjusted to meet the needs of the application.

The resulting biocide compositions in the form of an aqueous solution were found to be unexpectedly stable, especially at a pH of less than about 5.0. However when the pH is increased much above 5.0, and the biocide composition is contacted by an oxidizable organic, the biocide composition undergoes extremely vigorous decomposition even at relatively low concentrations. The reduction of the biocide compositions of the invention results in formation of reactive oxygen species. Once the biocide composition is produced, the biocide composition can be applied to applications and the pH can be adjusted to meet the needs of the application.

The biocide and bleaching compositions were unexpectedly far more effective than solutions containing 10× the concentration of the same polyoxychlorine anion donor used in the composition. Furthermore in at least one instance, it was shown that a ceramic cylinder test solution having a total oxidizer concentration 28× higher was inferior to the test solution resulting from the composition of the invention.

Further still, it was discovered that reducing the molar ratio of polyoxychlorine anion to cyclic anhydride increased the activity of the biocide and bleach composition. Biocide and bleach compositions having only 20 wt % of the same polyoxychlorine anion had substantially higher reactivity with the spore laden proteinaceous deposits on the ceramic cylinders. This finding is counterintuitive to what was expected. Intuitively, higher concentrations of the same oxidant would be expected to be more active and reactive with the deposits. When combined with the cyclic anhydride however, the opposite was found to be the case. The molar ratio of cyclic anhydride to polyoxychlorine anion was found to be more relevant to reactivity than concentration of the oxidant or total amount of oxidants in the final solutions. These results indicate there is a synergistic effect resulting from combining polyoxychlorine anion with a cyclic anhydride. It has been determined the synergistic effect is the result of the formation of an organic acyl polyoxychlorine composition.

Unlike acid anhydride reactions with chlorite anion which results in conversion of chlorite anion (ClO₂⁻) anion to chlorine dioxide (ClO₂), the resulting biocide and bleach compositions of the invention results in the formation of reactive oxygen species.

Furthermore, of significant benefit is while the biocide compositions of the invention comprise chlorate and/or perchlorate, the reduction of the biocide composition results in compounds Generally Regarded As Safe (GRAS). The reduction of the biocide compositions results in a cascading release of oxygen, terminating with an organic acid. For example, succinyl chlorate is reduced to oxygen, chloride salt and succinic acid. These environmentally benign byproducts are suitable for use in food and impose negligible environmental impact.

In one embodiment of the invention, there is provided a biocide composition in the form of an aqueous solution comprising:

at least one organic acyl polyoxychlorine having the general formula

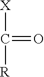

wherein (X) comprises a polyoxychlorine selected from at least one of a chlorate having the general formula ClO₃ and perchlorate having the general formula ClO₄;
wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water.

In another embodiment of the invention, a method of making a biocide composition comprising at least one organic acyl polyoxychlorine having the general formula

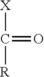

wherein (X) comprises a polyoxychlorine selected from at least one of a chlorate having the general formula ClO₃ and perchlorate having the general formula ClO₄;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water, the method comprising:

contacting an acid anhydride comprising two acyl groups bound at a common oxygen and wherein each of the acyl groups are bound to one of: an alkyl group having from 1 to 6 carbon atoms; an aryl group having 6 carbon atoms; a common carbon based backbone comprising 2 to 6 carbon atoms, with an aqueous solution comprising polyoxychlorine anions selected from at least one of chlorate anions having the general formula ClO₃⁻ and perchlorate anions having the general formula ClO₄⁻; and

reacting the acid anhydride and polyoxychlorine anions until the acid anhydride is substantially depleted to form the biocide composition having a pH of less than or equal to 7.0.

In another embodiment of the invention, a method of making a biocide composition comprising at least one organic acyl polyoxychlorine having the general formula

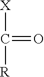

wherein (X) comprises a polyoxychlorine selected from at least one of a chlorate having the general formula ClO₃ and perchlorate having the general formula ClO₄;
wherein (R) comprising one of: 2 to 6 carbon based alkyl group terminating at a carboxyl functional group; 2 carbon based alkene group terminating at a carboxyl functional group; and water, the method comprising:

contacting a cyclic anhydride comprising two acyl groups bound to a common oxygen atom and having a common carbon based backbone having from 2 to 6 carbon atoms with an aqueous solution comprising polyoxychlorine anions selected from at least one of a chlorate anions having the general formula ClO₃⁻ and a perchlorate anions having the general formula ClO₄⁻; and

reacting the cyclic anhydride and polyoxychlorine anions until the cyclic anhydride is substantially depleted to form the biocide composition having a pH of less than or equal to 7.0.

In yet another embodiment of the invention, a biocide composition in the form of an aqueous solution comprising:

An organic diacyl dipolyoxychlorine having the general formula

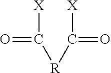

wherein (R) comprises a common carbon based backbone having from 2 to 6 carbon atoms;

wherein (X) comprises a polyoxychlorine selected from at least one of a chlorate having the general formula ClO₃ and perchlorate having the general formula ClO₄, and water.

In yet another embodiment of the invention, a method of killing microorganisms comprising: contacting microbiological organisms with an aqueous biocide composition comprising organic acyl polyoxychlorine having the general formula:

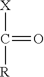

wherein (X) comprises a polyoxychlorine selected from at least one of a chlorate having the general formula ClO₃ and perchlorate having the general formula ClO₄; wherein (R) comprising at least one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group;

wherein the aqueous biocide composition has a pH of greater than 4.5.

In yet another embodiment of the invention, a method of killing microorganisms comprising: contacting microbiological organisms with an aqueous biocide composition comprising organic diacyl dipolyoxychlorine having the general formula:

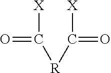

wherein (X) comprises a polyoxychlorine selected from at least one of a chlorate having the general formula ClO₃ and perchlorate having the general formula ClO₄; wherein (R) comprising a common carbon based backbone having from 2 to 6 carbon atoms;

wherein the aqueous biocide composition has a pH of greater than 4.5.

### DETAILED DESCRIPTION OF THE EMBODIMENT(S)

It has been discovered that stable organic acyl polyoxychlorine compositions can be produced in an aqueous solution and are extremely effective biocide compositions and bleach compositions. These compositions provide superior bleaching and biocidal efficacy compared to other oxidizing bleaches and biocides namely sodium hypochlorite, hydrogen peroxide, chlorine dioxide and peracetic acid.

Of particular interest is a biocide composition in the form of an aqueous solution comprising:

at least one organic acyl polyoxychlorine having the general formula

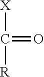

wherein (X) comprises a polyoxychlorine selected from at least one of a chlorate having the general formula ClO₃ and perchlorate having the general formula ClO₄;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water.

### BACKGROUND

Organic perchlorates have been used to initiate polymerization reactions for many years and they are still used today. Organic perchlorates are powerful oxidizers that are known to be extremely hazardous.

With reference to the publication “1988 Russ. Chem. Rev. 57 1041”, Titled “The Synthesis and Properties of Covalent Organic Perchlorates”.

Numerous methods for producing organic perchlorates are reviewed. Common methods discussed in the referenced paper include reacting alcohols with perchloric acid under tightly controlled temperatures to form perchloric acid mono and poly esters. However, the resulting organic perchlorates are oil based, and when contacted with dilute amounts of water decompose resulting in an “enormously powerful explosions”.

Furthermore, the reference discloses cyclic ethers including epoxides can be reacted with chlorine heptoxide in an organic solvent at 0° C. to produce diperchlorates.

The biocide compositions of the present invention can be produced using many techniques. Specific non-limiting examples include producing an organic diacyl dipolyoxychlorine by reacting in an organic solvent, an organic diacyl dichloride or organic diacyl alcohol with a source of perchlorate anions or chlorate anions. The resulting solution comprising the organic diacyl dipolyoxychlorine is then washed by diluting in an excess of acidified water to recover the organic diacyl dipolyoxychlorine in the form of an aqueous solution. The acidified water should be buffered to maintain a pH of no more than 5.0, more preferably less than 4.0.

The resulting biocide composition having the general formula:

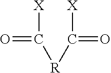

wherein (X) comprises a polyoxychlorine selected from at least one of a chlorate having the general formula ClO₃ and perchlorate having the general formula ClO₄; wherein (R) comprising a common carbon based backbone having from 2 to 6 carbon atoms;

and wherein the biocide composition is in the form of an aqueous solution.

Specific non-limiting examples include but are not limited to succinyl dichlorate and succinyl diperchlorate having the general formulas:

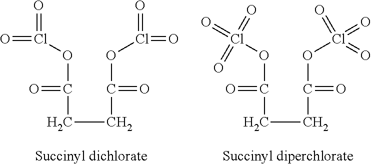

The preferred embodiment of the invention is an expedient method of preparing the biocide composition of the present invention comprising: contacting an acid anhydride with an aqueous solution comprising polyoxychlorine anions selected from at least one of chlorate anions having the general formula ClO₃⁻ and perchlorate anions having the general formula ClO₄⁻; reacting the acid anhydride and polyoxychlorine anions until the acid anhydride is substantially depleted;

wherein the acid anhydride comprising two acyl groups bound at a common oxygen and wherein each of the acyl groups are bound to at least one of: an alkyl group having from 1 to 6 carbon atoms; an aryl group having 6 carbon atoms; the same carbon based backbone comprising 2 to 6 carbon atoms; and

wherein the biocide composition having a pH of less than or equal to 7.0.

The resulting organic acyl polyoxychlorine having the general formula:

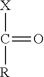

wherein (X) comprises a polyoxychlorine selected from at least one of a chlorate having the general formula ClO₃ and perchlorate having the general formula ClO₄;

wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and

wherein the biocide composition is in the form of an aqueous solution.

Specific non-limiting examples include but are not limited to succinyl chlorate and succinyl perchlorate having the general formulas:

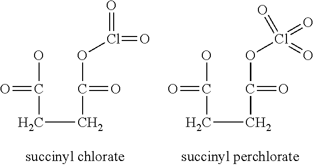

The expedient methods produce aqueous biocide compositions and bleach compositions and allows for ex-situ as well as in-situ generation of the said composition, greatly increasing their utility. The expedient method of producing the biocide and bleach composition also eliminates the explosive hazards associated with producing and handling organic chlorate and organic perchlorates, and simplifies production by eliminating the need to separate the composition from the organic mother solvent.

The use of the said polyoxychlorine anions with acid anhydride results in a biocide compositions and bleaching compositions with excellent stability until such time the solution contacts microorganisms, proteinaceous deposits and suspensions and oxidizable organics. The compositions of the invention and their respective biocide and bleaching solutions demonstrate excellent compatibility with many organic acids, acid anhydrides, and surfactants such a block copolymers exemplified by Pluronic 31R1, and Pluronic F127. This greatly expands their use in formulations and applications where detergency, increased wetting, and dispersants are beneficial.

The biocide and bleach compositions of the invention can be produced by solid reactants, liquid reactants or a combination of solid and liquid reactants. The solid compositions may be in the form of a powder, granules and tablet.

As used herein, the term “aqueous solution” means the solution comprises water. The use of the term water however does not imply the water is necessarily pure or removed of mineral salts and gases common to most waters.

As used herein, “cyclic anhydride” describes compounds comprising two acyl groups bound to a common oxygen atom and having a common carbon based backbone of 2 to 6 carbon atoms. Specific non-limiting examples of cyclic anhydrides include but are not be limited to succinic anhydride, methyl succinic anhydride, ethyl succinic anhydride, glutaric anhydride, adipic anhydride, maleic anhydride, pimelic anhydride, phthalic anhydride, suberic anhydride and the like. The carbon based backbone may include substituted branches as illustrated by methyl succinic anhydride and ethyl succinic anhydride. Backbone does not limit the carbon backbone structure to a simple chain of carbon atoms.

When a cyclic anhydride is reacted with a chlorate anion or perchlorate anion, one of the two acyl groups bound to the oxygen atom is cleaved from the oxygen, forming a reactive acyl group. The reactive acyl group is bound to a carbon based backbone comprising from 2 to 6 carbon atoms and terminating at a carboxyl functional group. The reactive acyl group reacts with the chlorate anion or perchlorate anion resulting in formation of the biocide composition comprising an acyl polyoxychlorine. A specific non-limiting example of an organic acyl polyoxychlorine resulting from a cyclic anhydride is succinyl chlorate having the general formula:

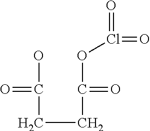

wherein what was the reactive acyl group is shown bound by a chlorate having the general formula ClO₃, and a carbon based backbone comprising H₂C—CH₂ and terminating at a carboxyl functional group.

As used herein, “acid anhydride” describes compounds comprising two acyl groups bound at a common oxygen and wherein each of the acyl groups are bound to at least one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group. Specific non-limiting examples of acid anhydrides include but are not be limited to acetic anhydride, propanoic anhydride, ethanoic propanoic anhydride, butanoic anhydride, pentanoic anhydride, benzoic anhydride, succinic anhydride, maleic anhydride, phthalic anhydride, glutaric anhydride and the like.

When an acid anhydride is reacted with a chlorate anion or perchlorate anion, one of the two acyl groups bound to the oxygen atom is cleaved from the oxygen resulting in the formation of a reactive acyl group and releasing a carboxyl group. The reactive acyl group forms an acyl polyoxychlorine by reaction with either a chlorate or perchlorate anion.

An acid anhydride comprising two acyl groups bound to a common oxygen and wherein each acyl group is bound to its own 1 to 6 carbon based alkyl group results in the formation of an acyl polyoxychlorine bound to a 1 to 6 carbon based alkyl group, and a carboxylic acid comprising a carboxyl group bound to a 1 to 6 carbon based alkyl group. One non-limiting example comprises acetic anhydride reacting with an aqueous solution of chlorate anions to produce a solution comprising acetic acid and acetyl chlorate.

An acid anhydride comprising two acyl groups bound to a common oxygen and wherein each acyl group is bound to its own aryl group results in the formation of an acyl polyoxychlorine bound to a 6 carbon aryl group, and a carboxylic acid comprising a carboxyl group bound to a 6 carbon aryl group. One non-limiting example comprises benzoic anhydride reacting with an aqueous solution of chlorate anions to produce a solution comprising benzoic acid and benzoyl chlorate.

An acid anhydride comprising two acyl groups bound to a common oxygen atom and a carbon based backbone of 2 to 6 carbon atoms is defined as a “cyclic anhydride”, and results in the formation of an acyl polyoxychlorine bound to either a 2 to 6 carbon based allyl group terminating at a carboxyl functional group, or a 2 carbon based alkene group terminating at a carboxyl functional group. One specific non-limiting example of an acid anhydride resulting in an acyl polyoxychlorine comprising a 2 to 6 carbon based alkyl group terminating at a carboxyl functional group is succinic anhydride. One non-limiting example of an acid anhydride resulting in an acyl polyoxychlorine comprising a 2 carbon based alkene group terminating at a carboxyl functional group is maleic anhydride.

An acid anhydride comprising two acyl groups bound to a common oxygen and common 6 carbon aryl group results in the formation of an acyl polyoxychlorine bound to a 6 carbon aryl group terminating at a carboxyl functional group. One specific non-limiting example is phthalic anhydride.

As used herein, “common carbon based backbone having from 2 to 6 carbon atoms” describes the basic carbon structure onto which both of the acyl groups and any substituted groups are bound. One specific non-limiting example is a starting acid chloride comprising methyl phthalyl dichloride reacted with chlorate anions to produce a methyl phthaloyl dichlorate. The common carbon based backbone comprises a 6 carbon phenyl group. The carbon atoms comprising the substituted methyl group and acyl groups are not included in the carbon atom count as it pertains to the “common carbon based backbone having from 2 to 6 carbon atoms”. Another non-limiting example is a cyclic anhydride represented by maleic anhydride wherein the common carbon based backbone comprises a 2 carbon alkene group onto which the two acyl groups are bound. Yet another example is a cyclic anhydride represented by succinic anhydride wherein the common carbon based backbone comprises a 2 carbon alkyl group onto which the two acyl groups are bound.

As used herein, “polyoxychlorine anions” pertains to the production of the organic acyl polyoxychlorine. Polyoxychlorine anions comprise chlorate anions and/or perchlorate anions having the general formulas ClO₃⁻ and ClO₄⁻ respectively. The polyoxychlorine anions are selected from an alkali and alkali earth metal chlorate (ClO₃⁻) and alkali and alkali earth metal perchlorate (ClO₄⁻). Specific non-limiting examples include but are not be limited to: lithium chlorate, sodium chlorate, potassium chlorate, magnesium chlorate, calcium chlorate, lithium perchlorate, sodium perchlorate, potassium perchlorate, magnesium perchlorate, calcium perchlorate. Ammonium chlorate and ammonium perchlorate may also be suitable in some applications for the production of organic acyl polyoxychlorine.

As used herein, “polyoxychlorine” pertains to the general formula of the organic acyl polyoxychlorine and comprises at least one of chlorate having the general formula ClO₃ and perchlorate having the general formula ClO₄. The polyoxychlorine is bound to the acyl group of the organic acyl polyoxychlorine.

As used herein, “acid anhydride is substantially depleted” and “cyclic anhydride is substantially depleted” describes when the biocide composition or bleach composition has essentially been produced and is ready for use. The anhydrides have limited solubility and reaction with the polyoxychlorine anion results in the production of the organic acyl polyoxychlorine based biocide and bleach compositions. When the acid anhydride (or cyclic anhydride) is depleted, no additional biocide or bleach composition is produced. Therefore, substantially depleted shall mean when approximately 95% of the acid anhydride and/or cyclic anhydride used to produce the biocide composition has been either reacted with the polyoxychlorine to produce the biocide composition or has hydrolyzed to its parent carboxylic acid. A specific non-limiting example is: combining succinic anhydride and sodium chlorate in an aqueous solution and allowing them to react to produce succinyl chlorate until at least 95 wt % of the succinic anhydride added to produce the biocide composition is either converted to succinyl chlorate or hydrolyzed to form succinic acid.

As used herein, “alkalinity donor” consumes hydrogen ions, thereby inducing an increase in the pH of the biocide solution and bleaching solution resulting from the compositions of the invention being contacted with water. Alkalinity donors are selected from alkali and alkali earth metals of bicarbonate, alkali and alkali earth metals of carbonate, alkali and alkali earth metals of phosphate, alkali and alkali earth metals of borate. Specific non-limiting examples include sodium bicarbonate, potassium bicarbonate, sodium carbonate, potassium carbonate, disodium phosphate, trisodium phosphate, sodium borate, sodium metasilicate, and the like.

As used herein, “reactive oxygen species” are any combination or variants of oxygen and oxygen radicals that are effective oxidizers. Specific non-limiting examples of reactive oxygen species include but are not limited to singlet oxygen, superoxide, and hydroxyl radicals.

As used herein, “biocide composition” describes an aqueous solution comprising the compositions of the invention. The biocide compositions inactivate a broad-spectrum of microbiological organisms, and can be optimized to meet the requirements to be classified as a disinfectant, sanitizer, and/or sterilant.

As used herein, “proteinaceous” describes any of a group of complex organic macromolecules that contain carbon, hydrogen, oxygen, nitrogen, and usually sulfur and are composed of one or more chains of amino acids. Proteins are fundamental components of all living cells and include many substances, such as enzymes, hormones, and antibodies that are necessary for the proper functioning of an organism.

As used herein, “organic based contaminants” are carbon based compounds that can be at least partially oxidized by reactive oxygen species.

As used herein, “weight percent” and “wt %” unless otherwise stated is based on the total weight of the biocide solution.

As used herein, “effective amount of combustion suppressing boron donor” defines an effective amount of boron containing compound exemplified by borax and boric acid that can reduce the combustion rate of the solid composition to a packing group having lower transportation and/or storage restrictions. Division 5.1 Oxidizer Testing in accordance with the Code of Federal Regulations, Title 49, and the United Nations Transportation of Dangerous Goods-Manual of Test and Criteria, Fourth revised edition (2003). Solid Division 5.1 materials are assigned packing groups using the following criteria [49 CFR .sctn.173.127(b)]: (i) Packing Group I is the sub-classification of any material which, in the 4:1 or 1:1 sample to cellulose ratio (by mass) tested exhibits a mean burning time less than the mean burning time of a 3:2 mixture, by mass, of potassium bromate and cellulose. (ii) Packing Group II is the sub-classification of any material which, in the 4:1 or 1:1 sample to cellulose ratio (by mass) tested exhibits a mean burning time less than the mean burning time of a 2:3 mixture, by mass, of potassium bromate and cellulose, and the criteria for Packing Group I are not met. (iii) Packing Group III is the sub-classification of any material which, in the 4:1 or 1:1 sample to cellulose ratio (by mass) tested exhibits a mean burning time less than the mean burning time of a 3:7 mixture, by mass, of potassium bromate and cellulose, and the criteria for Packing Groups I and II are not met.

As used herein, the term “tablet” refers to any geometric shape or size that comprises at least the ingredients of the compositions of the invention. The ingredients of the composition are agglomerated into a single mass to form a tablet. The tablet, upon contact with water produces a biocide solution.

As used herein, the term “recirculating systems” describes any open aqueous system that consist of a reservoir of water and a system of piping to transport the water, and wherein the water transported through the piping is eventually returned to the reservoir. Examples of recirculating systems include but are not limited to: cooling systems such as cooling towers and cooling ponds, swimming pools, fountains and feature pools.

As used herein “food processing applications” include those aspects within the process that utilize antimicrobial treatments to reduce the potential of spread of infectious disease. Applications include: vegetable and fruit washing; cleaning and sanitizing of food processing equipment; cleaning and sanitizing of animal carcasses, poultry, meat, rabbit, and egg products, treatment of poultry and animal habitats.

As used herein, “food product surfaces” include: meat carcasses of beef, pork, poultry, and fish; fruit surfaces, and vegetable surfaces.

As used herein, “hard surfaces” include: countertops; floors; walls; tables; cabinets; doors; doorknobs; food processing equipment, and the like.

As used herein, “surgical instruments” include: endoscopes; scalpels; forceps, and other instruments that require sterilization.

As used herein, “cold water sterilant” is a biocide composition used to sterilize endoscopes and other surgically used instruments that are susceptible to damage from heat.

Polyoxychlorine anion donors useful in the practice of the invention include alkali metal and alkali earth salts of chlorate, and perchlorate. Specific non-limiting examples include lithium chlorate, sodium chlorate, potassium chlorate, magnesium chlorate, calcium chlorate, lithium perchlorate, sodium perchlorate, potassium perchlorate, magnesium perchlorate, calcium perchlorate.

Alkalinity donors consume hydrogen ions, thereby inducing an increase in the pH of the aqueous biocide composition and bleaching composition. Alkalinity donors maybe included during the generation of the biocide and bleach compositions or may be used to activate the acidified biocide and bleach compositions. Specific non-limiting examples include sodium bicarbonate, potassium bicarbonate, sodium carbonate, potassium carbonate, disodium phosphate, trisodium phosphate, sodium borate, sodium metasilicate and the like. An alkalinity donor may be provided by aqueous solutions being treated by the biocide composition or bleach composition.

Acid anhydrides suitable for use in this invention are those that react with the polyoxychlorine anion when the composition is contacted with water to produce at least one of a biocide solution and bleach solution. Specific non-limiting examples of acid anhydrides include but are not be limited to succinic anhydride, maleic anhydride, N-caprylic anhydride, acetic anhydride.

Aqueous biocide compositions should be produced while sustaining a pH of less than or equal to 7.0. If the biocide composition is not going to be used expeditiously, it is desirable to produce the biocide composition while sustaining the pH of less than 6.0. If the biocide composition is to be stored for more than a few days, it is desirable to produce the biocide composition while sustaining a pH of less than 5.0.

Sustaining a pH of less than 7.0 during the production of the organic acyl polyoxychlorine is desirable in order to obtain the higher yields of organic acyl polyoxychlorine. As is illustrated in the following results, elevated pH before or during the production of the organic acyl polyoxychlorine significantly diminishes the yield as illustrated by the low activity.

While the final pH was below 7.0, using sources of alkalinity such as sodium carbonate resulted in undesirable yields. This is believed to be due to the rapid dissolution of the alkalinity which elevates the pH of the aqueous solution. The solubility of the acid anhydride is limited, so it takes some time for the acid anhydride to dissolve, react with the polyoxychlorine anion and form organic acyl polyoxychlorine, and reduce the pH by formation of carboxylic acid. At a pH above 6.0, test results illustrate that the reactivity of the organic acyl polyoxychlorine is substantially increased. As the pH increases further, the biocide composition becomes increasingly unstable. This is evident by the continuous release of gas and the short period of time the biocide composition shows reactivity to oxidizable organics such as whey protein when the biocide composition approaches a pH of 7.0.

By sustaining a pH below or near about 7.0 during the generation of organic acyl polyoxychlorine, the formation of organic acyl polyoxychlorine takes place without significant decomposition so that the resulting biocide composition is substantially rich in organic acyl polyoxychlorine.

In the test, the stronger and highly soluble alkalinity sources exemplified by sodium carbonate elevated the pH quickly, and it is believed much of the succinyl chlorate produced quickly decomposed before the pH was reduced sufficiently to stabilize the remaining succinyl chlorate.

In order to produce a “use as is” biocide composition, it is desirable to include a pH buffer such as sodium bicarbonate, disodium phosphate and the like to ensure that as the organic acyl polyoxychlorine is generated, the pH does not rise much above approximately 7.0 in order to reduce the level of decomposition of the organic acyl polyoxychlorine. However it is desirable to produce a biocide solution having a pH above 5.0 in so that it is ready to use as is, with need for additional pH adjustment to activate the biocide solution.

To produce a biocide composition suitable for storage or for use in applications where the aqueous solution treated with the biocide composition is greater than about 5.0, it is desirable to allow the aqueous solution to remain below 5.0 to further increase the stability of the organic acyl polyoxychlorine as it is produced, thereby increasing the resulting yield of the biocide composition.

Biocide compositions comprising succinyl chlorate and succinyl perchlorate were produced and tested for storage stability over a period of 15 days. The pH of the stock biocide compositions were measured and recorded. Whey protein was used to determine the relative reactivity of the biocide compositions. Before performing the whey protein test, sodium bicarbonate was added to a 10 ml sample of the biocide composition to increase the pH and activity of the organic acyl polyoxychlorine. The 10 ml sample was swirled to remove excess carbon dioxide gas. Then a small scoop of whey protein was added, the sample swirled, and the observed reactivity was recorded.

pH Effect on the Storage Stability of Aqueous Solutions Comprising
Succinyl Chlorate and Succinyl Perchlorate

| | | | | Biocide | Whey Protein Test |
|---|---|---|---|---|---|
| Sample ID | Sodium | Magnesium | Succinic | Composition | Storage (days) |
| 100 ml water | Chlorate | Perchlorate | Anhydride | pH | 8 days/15 days |
| 1 gm SA/1 gm ClO₃ | 1.0 gm | n/a | 1.0 gm | 3.60 | vigorous/vigorous |
| 1 gm SA/1 gm ClO₄ | n/a | 1.0 gm | 1.0 gm | 3.42 | vigorous/vigorous |

The stability test clearly illustrated that storing the biocide compositions is acid pH of less than 4.0 stabilized the biocide solution until such time as the pH was increased and the biocide composition was contacted by an oxidizable organic.

pH Effect on production of succinyl chlorate using strong alkali Na₂CO₃

| | Succinic Anhydride | | Sequence | |
|---|---|---|---|---|
| Sodium | w/Pluronic 31R1 | Sodium | of | Whey Protein |
| Chlorate | 10:1 wt ratio | Carbonate | Addition | Test |
| 1.0 gm | 1.0 gm | 1.0 gm | Na₂CO₃ | pH 6.32 |
| | | | added first | extremely weak |
| | | | pH~10.2 | poor activity |
| 1.0 gm | 1.0 gm | 1.0 gm | Added | pH 6.32 |
| | | | together | Better but weak |
| | | | | slow RxN w/whey |

In this test, sodium carbonate was used during the production of succinyl chlorate. The sodium carbonate was added at two different times to see the effect on production of the succinyl chlorate. The sample pretreated with sodium carbonate showed extremely weak reactivity with the whey protein even though the final pH of the biocide composition was less than 7.0. The addition of the sodium carbonate together with the succinic anhydride and sodium chlorate showed better results. However, the biocide composition was comparatively weak when compared to biocide solutions produced using either sodium bicarbonate as a bufferor no buffer addition at all. Regardless, the biocide composition was produced, but other more favorable methods are demonstrated and disclosed.

pH effect on generation of succinyl chlorate and activity

| | Succinic | | | |
|---|---|---|---|---|
| Sodium | Anhydride w/ | Sodium | Sequence of | Whey Protein |
| Chlorate | Pluronic 31R1 | Bisulfate | Addition | Test |
| 1.0 gm | 1.0 gm | 1.2 gm | NaHSO₄ | pH 2.70 |
| | | | added first | No observable |
| | | | pH~2.80 | Reaction |
| | | | 2.0 gm | pH 6.54 |
| | | | NaHCO₃ | vigorous w/foam |

In this example, the pH was brought to the other extreme by addition of sodium bisulfate to first suppress the pH. The succinic anhydride and sodium chlorate where then added and allowed to react to produce the succinyl chlorate. The resulting biocide composition was test for activity by addition of whey protein to a 10 ml sample. The test showed no observable reaction between whey protein and succinyl chlorate at a pH of 2.70. However, when sodium bicarbonate was added to elevate the pH above 5.0, the biocide composition reacted vigorously with the whey protein, generating large amounts of gas, resulting in formation of foam.

The molar ratio of polyoxychlorine anions comprising at least one of chlorate having the general formula ClO₃⁻ and perchlorate having the general formula ClO₄⁻ and acid anhydride ranges from 10:1 to 1:10 respectively, more preferably 5:1 to 1:5, and most preferably 2:1 to 1:2.

Acid anhydrides have limited solubility in the aqueous solutions comprising polyoxychlorine anions. In order to achieve desirable levels of conversion of the acid anhydride to the organic acyl polyoxychlorine, the acid anhydride and polyoxychlorine should be in intimate contact before the acid anhydride hydrolyzes to form its parent carboxylic acid. Powder or liquid compositions should be dispersed in the aqueous solution comprising the polyoxychlorine anions. Solid compositions in the form of granules of tablets by their very nature place the reactants comprising polyoxychlorine anions and acid anhydride in intimate contact.

Liquid or powered acid anhydrides should be mixed in the aqueous solution of effectively dispersed to form a suspension. This ensures intimate contact between the acid anhydride is intimately contacted with the peroxychlorine anions as the reactive acyl group is formed, thereby increasing the conversion of the acid anhydride to the desirable organic acyl polyoxychlorine instead of the undesirable hydrolysis of the reactive acyl group to a carboxylic acid.

Solid compositions of this invention may be in the form of powders, granules, and tablets. Solid composition may be packaged as a single composition, or as separate ingredients to be later mixed then added to water or individually added to water.

Solid compositions in the form of a tablet can be formed into a biocide solution using a multi-tablet chemical dispenser for ease of producing the biocide solution for higher use applications such as cooling towers or treatment of animal carcasses and fruit and vegetable washing.

Solid compositions in the form of granules and powders maybe dissolved in water then fed thru a chemical pump. Another method can be to feed the powder or granules thru a shot feeder wherein the solid composition is placed into a vessel, the vessel is sealed, water is piped into the vessel to dissolve the composition in which the biocide solution is formed, and dispense the biocide solution to the aqueous system to be treated such as a cooling tower, swimming pool, spa, and the like. Liquid biocide compositions can be made in advance and packaged into a drum. A chemical pump or educator system can be used to deliver the biocide composition.

Solid compositions may be packaged in single use packages. Examples include a single pouch in which a mixed solid composition is stored or a multi-compartment pouch or package. The single use package is opened and the contents are added to water and mixed to form the biocide composition. The biocide composition is then applied to hard surface such as counter tops, doorknobs, cabinets, and the like for the purpose of disinfection.

Additionally, solid compositions may be packaged in single use packages can be used for producing a cold water sterilant for use in hospitals and emergency medical units such as military field hospitals. The cold water sterilant allows sterilization of endoscopes and other equipment without the need for plasma or steam sterilization equipment. Premade liquid compositions may also be used as a cold water sterilant.

Solid and compositions can also be packaged as bleaches for laundry or formulated with dry or non-aqueous laundry detergents. Liquid biocide composition and bleach composition can be packaged and used as a non-chlorine bleach to laundry washing machines and for soaking prior to washing.

Further still, solid biocide compositions can be used to produce biocide solutions for the treatment of food product surfaces such as carcasses of beef, pork, poultry, and fish products. Liquid biocide compositions can be made in advance and are then diluted and applied to the carcasses of beef, pork, poultry, and fish.

Solid compositions can also be used to make biocide compositions to disinfect food processing equipment and animal habitats. Liquid biocide compositions can be made in advance to disinfect food processing equipment and animal habitats.

Surfactants can be incorporated into the composition or the biocide solution to reduce the surface tension, improve wetting, improve detergency, and provide foaming capability. Specific non-limiting examples include block copolymer surfactants sold under the trade name Pluronic® manufactured by BASF. Surfactants can also be useful for pretreating solid acid anhydrides to improve their dispersion in the aqueous solution to prevent coalescing or the anhydride and separation by settling or floatation.

Anti-caking agents can improve flowability and reduce clumping of dry compositions and ingredient. I can be advantageous to apply an anti-caking agent exemplified by magnesium carbonate light, untreated fumed silica and treated fumed silica. Fumed silica is sold under the trade name CAB-O-SIL® and is manufactured by Cabot Corporation. Anti-caking agents can also reduce the hygroscopic nature of the polyoxychlorine anion donors as well as the entire solid composition.

Dispersants such as tripolyphosphate can be useful in dispersing soils in sterilant and other applications in which the biocide solution must penetrate deposits to effectively inactivate microorganisms.

### Testing the Biocide Composition

AOAC method 966.04 is used to determine the sporicidal efficacy of an antimicrobial agent. The test uses ceramic cylinders that have been placed in a suspension of proteinaceous materials and soils which had been inoculated with Bacillus subtilis and C. Sporogenes. The coated cylinders are removed from the suspension and dried. This preparation embeds the spores in a heavily soiled proteinaceous matrix that protects the spores from the sporicide. The normally white ceramic cylinders acquire beige to tan color with some having brown areas due to heavier deposition.

Samples of the prepared ceramic cylinders where obtained from MicroChem laboratory Inc. of Euless, Tex.

All of the stock biocide solutions used in the test where prepared by mixing solid ingredients then adding the listed ingredients into 100 ml of water and mixing using a magnetic stirrer until clear and no suspended solids were observed. The activity of the biocide solution was tested by using the stock biocide solution as prepared, or by diluting the stock biocide solution, filling a vial to the 10 ml mark, then adding one of the prepared ceramic cylinders used for sporicidal testing. A stop watch was started when the ceramic cylinder was added, and observations were made to assess the speed and aggressiveness of the reaction by observing the rate at which gas was formed on the cylinder, the relative amount of gas released, the time lapsed until the gas formation terminated, and the color of the ceramic cylinder upon completion of either the termination of gas formation or termination of the test.

Acid anhydrides generally have slight to limited solubility in water. They slowly hydrolyze to their parent acid. When succinic anhydride is added in a granular/flake form to water that has been treated with sodium chlorate, the tendency is to either coalesce and sink to the bottom, or entrap gas and float. Since the chlorate anions must collide with the acid anhydride to convert the succinic anhydride to the desired succinyl chlorate, large clumps of succinic anhydride reduce the efficiency of conversion and subsequent yield of the succinyl chlorate. One way to improve the dispersion of a solid form of acid anhydride is to reduce the particle size of the acid anhydride and combine the acid anhydride with a surfactant.

A mixture was made by combining 5 grams of succinic anhydride was combined with 0.5 ml of Pluronic 31R1 which is a block copolymer of polyethylene oxide and polypropylene oxide. The two were mixed, then 9.5 grams of sodium bicarbonate where added and mixed. The ingredients where added to a coffee grinder and ground to form a fine fluffy powder that was easily removed from the grinder.

100 ml of cold water (8° C.) was added to a flask and 1.5 grams of the mixture was combined with 0.50 grams of sodium chlorate then added to the flask. The solution was manually mixed for approximately 30 seconds and allowed to rest undisturbed. The solution was hazy and no settling of particulate was observed. After approximately 15 minutes the solution was clear, the pH was 6.28. The resulting solution comprises a biocide composition of succinyl chlorate.

To a 10 ml sample of the biocide composition a ceramic cylinder prepared using the protocol from AOAC 966.04 was added. The reaction upon addition of the cylinder was spontaneous. Vigorous gas evolution occurred and after 35 seconds the reaction appeared to be completed.

The test illustrated that combining solid acid anhydride with surfactant exemplified by Pluronic 31R1 and reducing the particle size resulted in a readily dispersible composition that did not require continuous mixing. This would be advantageous for producing powerful biocide composition and bleaching compositions from solid reagents where equipment for mixing is not available. For example, one non-limiting example is an expedient cold sterilant for sterilizing endoscopes in field hospitals for the military. A solid composition for producing the cold water sterilant could be made by adding the solids to a jar, shaking until the solution is effectively dispersed, and allowing the reactant sufficient time to form the biocide composition.

In this example, 20 grams of succinic anhydride was combined with 1.0 grams Pluronic F127 and ground in a coffee grinder to form a mixture. 1.0 gram of the mixture was combined with 1.0 grams sodium chlorate and 1.0 gram sodium bicarbonate and added to 100 ml of water and mixed. The solution was clear in approximately 3 minutes, the pH was 6.05. A 2.5 ml sample of biocide solution was combined with 7.5 ml of water and swirled. A scoop of whey protein was added and swirled. The sample demonstrated excellent decomposition of the whey protein.

These, tests illustrate that combining a surfactant exemplified by the block copolymers sold under the trade name Pluronic® to the ground solid acid anhydride significantly improves the dispersion of the acid anhydride and results in effective conversion of the acid anhydride to the desired organic acyl polyoxychlorine resulting the formation of the biocide composition. The formation of the biocide composition using this technique can be achieved with very limited mechanical mixing.

### Testing Variations of the Biocide Composition

TABLE 1

| | Sodium | Magnesium | Succinic | Alkalinity | Observation |
|---|---|---|---|---|---|
| SAMPLE | Chlorate | Perchlorate | Anhydride | NaHCO₃ | Ceramic Cylinder test |
| #1ClO3 | 2.0 gm | na | 1.0 gm | 1.0 gm | pH-6.01 of stock solution |
| | | | | | 2.5 ml stock soln + 7.5 ml water |
| | | | | | slow gas evolution initially |
| | | | | | increasing gas evolution |
| | | | | | completed in approx 10 |
| | | | | | minutes |
| #2ClO3 | 0.2 gm | na | 1.0 gm | 1.0 gm | pH 5.64 of stock soln. |
| | | | | | 5 ml stock soln. + 5mlwater |
| | | | | | Rapid evolution of gas |
| | | | | | completed in approx 2 |
| | | | | | minutes |
| #1CO4 | na | 0.2 gm | 1.0 gm | 1.0 gm | pH 5.79 stock soln. |
| | | | | | 5 ml stock soln. + 5 ml water |
| | | | | | appears slower than #2ClO3 |
| | | | | | gas evolution completed 4 |
| | | | | | min. |

The results of table 1 unexpectedly showed as the molar ratio of acid anhydride to polyoxychlorine anion increased, the activity of the biocide and bleaching solution increased. In the ceramic cylinder test, the diluted solution identified as samples #2ClO3 having only 20% of the active oxidizer (sodium chlorate) compared to sample #1ClO3, yet the results showed the reactivity of #2ClO3 dramatically increased. The data shows that as the molar ratio of succinic anhydride to chlorate anion increased, the availability of reactive oxygen species increased even though the solution was 80% lower in chlorate. This is counterintuitive since the chlorate is the oxidizer component of the composition. Furthermore, the sample identified as #1ClO4 comprising magnesium perchlorate resulting from a stock solution having 0.2 grams of magnesium perchlorate was far more effective than the solution resulting from a stock solution having 2.0 grams of sodium chlorate. The result of these test shows that combining the sodium chlorate and magnesium perchlorate with succinic anhydride resulted in some form of intermediate that, when placed in contact with the ceramic cylinder, resulted in formation of reactive oxygen species and subsequent evolution of gas.

TABLE 2

| | | | | Succinic | | Ceramic Cylinder in 10 ml |
|---|---|---|---|---|---|---|
| | NaClO₂ | NaClO₃ | Percarbonate | Acid | | AOAC 966.04 |
| Sample | gm | gm | gm | gm | Sequence | 1 min. Observation |
| #1A | na | 0.71 gm | 2.10 gm | 2.00 gm | mixture | No relevant reaction |
| | | | | | | pH 5.72 |
| #2A | 1.10 gm | na | 2.10 gm | 2.00 gm | mixture | Slow reaction - gas |
| | | | | | | formation, pH 5.75 |

The results of Table 2 illustrate under the conditions tested, the chlorate did not work synergistically with the sodium chlorate using succinic acid as the acid donor. However chlorite did induce a reaction in the presence of hydrogen peroxide with succinic acid as the acid donor. Results further show that combining the ingredients of sample #2A to form a mixture, and adding the mixture to water to provide approximately a 5 wt % solution, resulted in a slow but favorable decomposition of the proteinaceous deposit on the ceramic cylinder.

Furthermore, the results of Table 2 illustrate the spore laden proteinaceous deposit on the ceramic cylinder used in AOAC method 966.04 had no observable to slow reaction with the undiluted solutions comprised of various oxidants including polyoxychlorine anion donors of the invention. Furthermore, the concentrations of polyoxychlorine anion donor in the ceramic cylinder solution labeled #2A is greater than 10× higher than the test solutions labeled #2ClO3 and #1ClO4 illustrated in table 1, yet the results in table 2 are undesirable. Further still, the total amount of oxidant in the cylinder test solutions illustrated in table 2 are 28× higher than the total amount of oxidants in the cylinder test solutions of table 1 which comprise the composition of the invention. The comparison of the data from table 1 and table 2 clearly illustrated the dramatic improvements in efficacy resulting from the compositions of the invention.

Samples of biocide solutions were prepared by combining measured amounts ingredients illustrated in Table 3, then adding them to 100 ml of water while mixing using a magnetic stirrer.

TABLE 3

| | Sodium | Magnesium | Sodium | Succinic | | |
|---|---|---|---|---|---|---|
| Sample | Chlorate | Perchlorate | Percarbonate | Anhydride | Sequence | Observation |
| #5A | 1.00 gm | na | 2.00 gm | 1.50 gm | mixture | pH 6.77 |
| | | | | | | Aggressive reaction |
| | | | | | | 30 seconds |
| | | | | | | reaction complete |
| | | | | | | cylinder white |
| #6A | na | 1.00 gm | 2.00 gm | 1.50 gm | mixture | pH 6.73 |
| | | | | | | Aggressive reaction |
| | | | | | | 15-20 seconds |
| | | | | | | reaction complete |
| | | | | | | cylinder white |

The results unexpectedly illustrate that polyoxychlorine anion donors with 3 or more moles of oxygen in the presence of hydrogen peroxide and succinic anhydride provided a biocide solution with a high level of reactivity toward the spore laden proteinaceous deposits. The sample using magnesium perchlorate showed the potential for even more favorable results than the sodium chlorate sample. This may be due to the higher level of oxygen being liberated from the perchlorate. Furthermore, there was no indication of chlorine dioxide being generated in the biocide solution.

TABLE 4

| Sample | 24 hr | 48 hr |
|---|---|---|
| #5A | 2 ml soln to 8 ml water | 2 ml soln to 8 ml water |
| | (0.90 wt % solids) | (0.90 wt % solids) |
| | bubble formation on surface | Same observations as 24 |
| | evolution of gas - increased | hr test |
| | with movement. 4.5 minutes | Activity remains high |
| | cylinder is white. No | |
| | apparent gas formation | |
| #6A | 2 ml soln to 8 ml water | 2 ml soln to 8 ml water |
| | (0.90 wt % solids) | (0.90 wt % solids) |
| | Readily forms gas with | Comparable to 24 hr test. |
| | evolution | Cylinder is white and gas |
| | Reaction nears completion | formation completed in |
| | is 2 min cylinder white in | approx 2 minutes |
| | appearance | |

Table 4 comprises data from follow-up test for samples of biocide solution produced in support of the data in table 3. These tests illustrate the relative stability of the biocide solution after 24 hrs and 48 hours of storage. The biocide sample identified as #5A and #6A where diluted with fresh water to achieve approximately a 0.9 wt % solids (ingredients). The results unexpectedly show the samples remained highly active and imparted a strong reaction with the proteinaceous deposits on the ceramic cylinders. Furthermore, there was no indication of chlorine dioxide generation in the biocide solution.

TABLE 5

| Sample | Sodium | Succinic | | |
|---|---|---|---|---|
| Peracid | Percarbonate | Anhydride | Sequence | Observations |
| | 3.00 gm | 3.00 gm | mixture | pH 6.56 |
| | | | | 2 ml soln to 8 ml water |
| | | | | slow gas formation |
| | | | | no continued gassing |
| | | | | deposits remain after |
| | | | | 10 min |
| | | | | cylinder white after |
| | | | | 20 min |

Table 5 demonstrates the results of a solution comprising persuccinic acid produced by reacting 3.0 gm sodium percarbonate with 3.0 gm succinic anhydride in 50 ml of water for 30 minutes followed by dilution with another 50 ml of water. The final dilutions used to treat the ceramic cylinder provided a higher concentration of actives than for the examples of biocide solutions of the invention illustrated in tables 1 and 3. The persuccinic acid did not demonstrate the ability to decompose the proteinaceous deposits at a rate comparable to the composition of the invention.

TABLE 6

| Sample | NaClO₃ | Percarbonate | Sequence | Observation |
|---|---|---|---|---|
| Alkaline | 1.00 gm | 2.00 gm | mixture | pH 9.8 |
| | | | | gas formation of surface |
| | | | | Slow compared to |
| | | | | Succinic anhydride |
| | | | | samples |

Table 6 shows that concentrated solutions comprising a polyoxychlorine and peroxide donor do not provide performance comparable to biocide solutions that result from composition of the invention that include succinic anhydride.

TABLE 7

| | | | | | Observation |
|---|---|---|---|---|---|
| | Sodium | Sodium | Succinic | Alkalinity | Ceramic |
| SAMPLE | Chlorate | Persulfate | Anhydride | NaHCO₃ | Cylinder test |
| #1ClO3P | 2.0 gm | 2.0 gm | 0.5 gm | 0.5 gm | pH 6.65 stock |
| | | | | | soln. 2 ml stock |
| | | | | | soln. to 8 ml |
| | | | | | wate rapid gas |
| | | | | | evolution |
| | | | | | completed in |
| | | | | | approx 4 min. |

Table 7 illustrates the results of a biocide and bleaching solution produced by the composition of the invention being contacted with water. This example included sodium persulfate to further enhance the potential for bleaching and synergistic oxidation. The biocide and bleaching solution showed excellent result on the test ceramic cylinder at approximately a 1 wt % solution.

TABLE 8

| | Sodium | Sodium | Succinic | |
|---|---|---|---|---|
| SAMPLE | Chlorate | Chlorite | Anhydride | Observation |
| ClO3ClO2 | 0.2 gm | 0.1 gm | 1.0 gm | ClO2 = 354 ppm |

Table 8 illustrates the biocide and bleach solutions resulting from the composition of the invention can also be formulated to produce chlorine dioxide by addition of an alkali or alkali earth chlorite.

TABLE 9

| | Sodium | Sodium | Succinic | Alkalinity | Whey protein |
|---|---|---|---|---|---|
| SAMPLE | Chlorate | Persulfate | Anhydride | NaHCO₃ | reactivity |
| #1CIO3P | 2.0 gm | 2.0 gm | 0.5 gm | n/a | pH 3.93 |
| | | | | | none detected |
| | | | | 0.5 gm | pH 6.65 |
| | | | | | Extremely |
| | | | | | reactive vigorous |
| | | | | | evolution of gas |

Table 9 illustrates the results of one composition of the invention showing the biocide and bleaching solution showing no significant reaction with whey protein when the pH was below 4.0. However with the addition of sodium bicarbonate, the pH was elevated to above 6.0, the result obtained with addition of whey protein was dramatically changed. The evolution of gas was vigorous. This indicates that biocide and/or bleaching solutions could be produced in advance and stored under low pH conditions until ready for use. This would be comparable for example to liquid bleach (Clorox®), where bleach is stored under alkaline conditions to improve stability.

To 100 ml of tap water, 5 grams of magnesium perchlorate was added and mixed, followed by addition of 5 grams of succinic anhydride. The aqueous solution was vigorously mixed until no succinic anhydride was observable in the solution. Approximately 25 ml of solution was stored in a flask and allowed to dry by slowly evaporating the water at atmospheric conditions. The bottom of the flask had a film of crystals having an appearance similar to snowflakes. 25 ml of cold tap water was added and swirled to dissolve the crystals. A 10 ml vial was filled and a small amount of sodium bicarbonate was added and swirled to elevate the pH to over 5.0. Whey protein was added and the vial was swirled. The whey protein rapidly decomposed forming a cloud of gas and formation of foam on the top of the vial.

This test showed that an acidic aqueous solution of succinyl perchlorate is sufficiently stable to form a solid succinyl perchlorate. The solid succinyl perchlorate could be reconstituted to form an aqueous solution while retaining its reactivity toward whey protein.

Organic perchlorates have been known to be explosive in concentrated liquid and solid forms. It may be advantageous to include an additive in liquid solutions sold in the commercial and retail markets that induces decompositions when the organic acyl polyoxychlorine is concentrated, thereby preventing formation of solid crystals. Non-limiting examples of methods that could be used to prevent the concentrating of organic acyl polyoxychlorine compounds could include adding a substance to the aqueous biocide composition that crystallizes when concentrated above its saturation point and functions as a catalyst to initiate decomposition at the acyl polyoxychlorine bond. Yet another example could be a substance that elevates the pH as the solution concentrates, thereby destabilizes the biocide composition and initiating decomposition.

TABLE 10

| Sample | | | Magnesium | 10 ml vial | Whey |
|---|---|---|---|---|---|
| 100 ml H₂O | Maleic | Acetic | Perchlorate | NaHCO₃ | RxN |
| #1 Alkene | 1.0 gram | n/a | 1.0 gram | x | Vigorous |
| #1 Alkyl | n/a | 1.0 gram | 1.0 gram | x | vigorous |

Test were conducted using acetic anhydride and maleic anhydride reacted with magnesium perchlorate. The resulting solution where stable under acidic conditions but reacted vigorously when the pH was buffered using sodium bicarbonate followed by addition of whey protein.

What is claimed is:

1. A biocide composition in the form of an aqueous solution comprising:
at least one organic acyl polyoxychlorine having the general formula 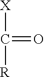
wherein (X) comprises a polyoxychlorine selected from at least one of a chlorate having the general formula ClO₃ and perchlorate having the general formula ClO₄; wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water.

2. The biocide composition according to claim 1, wherein the organic acyl polyoxychlorine comprises at least one of succinyl chlorate and succinyl perchlorate having the general formulas:

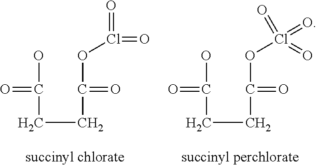

3. The biocide composition according to claim 1, wherein the organic acyl polyoxychlorine comprises at least one of glutaryl chlorate and glutaryl perchlorate having the general formulas:

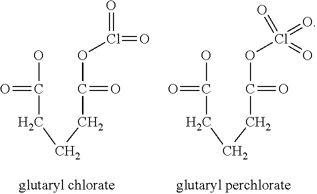

4. The biocide composition according to claim 1, wherein the organic acyl polyoxychlorine comprises at least one of adipoyl chlorate and adipoyl perchlorate having the general formulas:

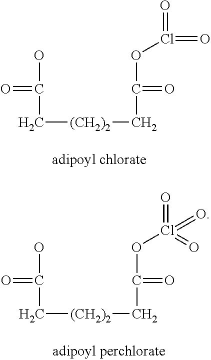

5. The biocide composition according to claim 1, wherein the organic acyl polyoxychlorine comprises at least one of acetyl chlorate and acetyl perchlorate having the general formulas:

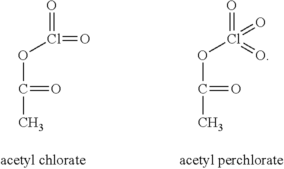

6. The biocide composition according to claim 1, wherein the organic acyl polyoxychlorine comprises at least one of maleyl chlorate and maleyl perchlorate having the general formulas:

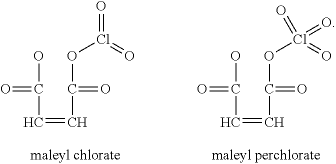

7. A method of making a biocide composition comprising at least one organic acyl polyoxychlorine having the general formula 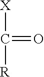
wherein (X) comprises a polyoxychlorine selected from at least one of a chlorate having the general formula ClO₃ and perchlorate having the general formula ClO₄; wherein (R) comprising one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group; 6 carbon aryl group; and water, the method comprising:
contacting an acid anhydride comprising two acyl groups bound at a common oxygen and wherein each of the acyl groups are bound to one of: an alkyl group having from 1 to 6 carbon atoms; an aryl group having 6 carbon atoms; a common carbon based backbone comprising 2 to 6 carbon atoms, with an aqueous solution comprising polyoxychlorine anions selected from at least one of chlorate anions having the general formula ClO₃⁻ and perchlorate anions having the general formula ClO₄⁻; and
reacting the acid anhydride and polyoxychlorine anions until the acid anhydride is substantially depleted to form the biocide composition having a pH of less than or equal to 7.0.

8. The method according to claim 7, wherein the pH is less than 6.0.

9. The method according to claim 7, wherein the pH is less than 5.0.

10. A method of making a biocide composition comprising at least one organic acyl polyoxychlorine having the general formula 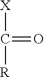
wherein (X) comprises a polyoxychlorine selected from at least one of a chlorate having the general formula ClO₃ and perchlorate having the general formula ClO₄; wherein (R) comprising one of: 2 to 6 carbon based alkyl group terminating at a carboxyl functional group; 2 carbon based alkene group terminating at a carboxyl functional group; and water, the method comprising:
contacting a cyclic anhydride comprising two acyl groups bound to a common oxygen atom and having a common carbon based backbone having from 2 to 6 carbon atoms with an aqueous solution comprising polyoxychlorine anions selected from at least one of a chlorate anions having the general formula ClO₃⁻ and a perchlorate anions having the general formula ClO₄⁻; and
reacting the cyclic anhydride and polyoxychlorine anions until the cyclic anhydride is substantially depleted to form the biocide composition having a pH of less than or equal to 7.0.

11. The method according to claim 10, wherein the pH is less than 6.0.

12. The method according to claim 10, wherein the pH is less than 5.0.

13. A biocide composition in the form of an aqueous solution comprising succinyl chlorate having the general formula 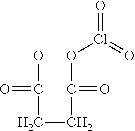
and water.

14. The biocide composition according to claim 13, wherein the biocide composition comprises a cold water sterilant.

15. A method of making a biocide composition in the form of an aqueous solution comprising succinyl chlorate having the general formula 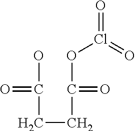
and water, the method comprising:
contacting succinic anhydride with an aqueous solution comprising chlorate anions having the general formula ClO₃⁻; and
reacting the succinic anhydride and chlorate anions until the succinic anhydride is substantially depleted to form the biocide composition having a pH of less than or equal to 7.0.

16. The method according to claim 15, wherein the pH is less than 6.0.

17. The method according to claim 15, wherein the pH is less than 5.0.

18. A biocide composition in the form of an aqueous solution comprising succinyl perchlorate having the general formula 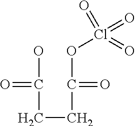
and water.

19. A method of making a biocide composition in the form of an aqueous solution comprising succinyl perchlorate having the general formula 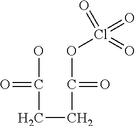
and water, the method comprising:
contacting succinic anhydride with an aqueous solution comprising perchlorate anions having the general formula ClO₄⁻; and
reacting the succinic anhydride and perchlorate anions until the succinic anhydride is substantially depleted to form the biocide composition having a pH of less than or equal to 7.0.

20. The method according to claim 19, wherein the pH is less than 6.0.

21. The method according to claim 19, wherein the pH is less than 5.0.

22. A biocide composition in the form of an aqueous solution comprising:
An organic diacyl dipolyoxychlorine having the general formula 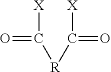
wherein (R) comprises a common carbon based backbone having from 2 to 6 carbon atoms;
wherein (X) comprises a polyoxychlorine selected from at least one of a chlorate having the general formula ClO₃ and perchlorate having the general formula ClO₄, and water.

23. The biocide composition according to claim 22, wherein the organic diacyl dipolyoxychlorine comprises succinyl dichlorate having the general formula:

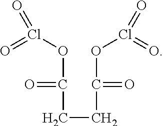

24. The biocide composition according to claim 22, wherein the organic diacyl dipolyoxychlorine comprises succinyl diperchlorate having the general formula:

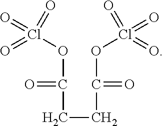

25. A method of making a biocide composition in the form of an aqueous solution comprising an organic diacyl dipolyoxychlorine having the general formula 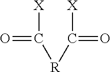
wherein (R) comprises a common carbon based backbone having from 2 to 6 carbon atoms,
wherein (X) comprises a polyoxychlorine selected from at least one of a chlorate having the general formula ClO₃ and perchlorate having the general formula ClO₄, and water, the method comprising:
contacting a diacyl dichloride group having a common carbon based backbone of 2 to 6 carbon atoms with a solution comprising an organic solvent and polyoxychlorine anions selected from at least one of a chlorate anions having the general formula ClO₃⁻ and a perchlorate anions having the general formula ClO₄⁻;
reacting the diacyl dichloride and polyoxychlorine anions to produce a solution substantially rich in organic diacyl dipolyoxychlorine; and
separating the organic diacyl dipolyoxychlorine with water to produce the aqueous biocide composition having a pH of less than 5.0.

26. A method of killing microorganisms comprising: contacting microbiological organisms with an aqueous biocide composition comprising organic acyl polyoxychlorine having the general formula: 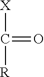
wherein (X) comprises a polyoxychlorine selected from at least one of a chlorate having the general formula ClO₃ and perchlorate having the general formula ClO₄; wherein (R) comprising at least one of: 1 to 6 carbon based alkyl group; 2 to 6 carbon based alkyl group terminating at a carboxyl functional group; 2 carbon based alkene group terminating at a carboxyl functional group; 6 carbon aryl group terminating at a carboxyl functional group;
wherein the aqueous biocide composition has a pH of greater than 4.5.

27. A method according to claim 26, further comprising forming the aqueous biocide by contacting an acid anhydride comprising two acyl groups bound at a common oxygen and wherein each of the acyl groups are bound to one of an alkyl group having from 1 to 6 carbon atoms; an aryl group having 6 carbon atoms; a common carbon based backbone comprising 2 to 6 carbon atoms, with an aqueous solution comprising polyoxychlorine anions selected from at least one of: chlorate anions having the general formula ClO₃⁻; perchlorate anions having the general formula ClO₄⁻; and reacting the acid anhydride and polyoxychlorine anions until the acid anhydride is substantially depleted to form the aqueous biocide.

28. A method of killing microorganisms comprising: contacting microbiological organisms with an aqueous biocide composition comprising organic diacyl dipolyoxychlorine having the general formula: 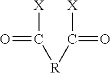
wherein (X) comprises a polyoxychlorine selected from at least one of a chlorate having the general formula ClO₃ and perchlorate having the general formula ClO₄; wherein (R) comprising a common carbon based backbone having from 2 to 6 carbon atoms;
wherein the aqueous biocide composition has a pH of greater than 4.5.
